(19) United States
(12) Patent Application Publication
(10) Pub. No.: US 2011/0293298 A1
(43) Pub. Date: Dec. 1, 2011

(54) IMAGE FORMING APPARATUS AND MAINTENANCE CONTROL METHOD FOR THE SAME

(75) Inventor: Yohei Doi, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/111,865

(22) Filed: May 19, 2011

Related U.S. Application Data
(60) Provisional application No. 61/348,610, filed on May 26, 2010.

(51) Int. Cl. G03G 15/00

(52) U.S. Cl. 399/37

(57) ABSTRACT

An image forming apparatus according to an embodiment includes a solar panel, an electric storage unit which is supplied with electric power from the solar panel and a commercial power supply and stores electricity, a power supply disconnection detecting unit which detects power supply disconnection from the commercial power supply, and a maintenance control unit for power supply disconnection which carries out maintenance control using stored electricity from the solar panel if the power supply disconnection from the commercial power supply is detected by the power supply disconnection detecting unit.

### CROSS-REFERENCE TO RELATED APPLICATION

This application is based upon and claims the benefit of priority from Provisional U.S. Application 61/348,610 filed on May 26, 2010, the entire contents of which are incorporated herein by reference.

### FIELD

Embodiments described herein relate generally to an image forming apparatus and a maintenance control method for the same.

### BACKGROUND

Conventionally, electric power stored in a secondary power supply or the like is used for assisting fixing power for a short time or when power consumption is low such as in standby mode. However, since the electric storage capacity for electric power stored in a secondary battery or the like is limited, a power supply must be switched to input from a commercial power supply when the stored electric power is no longer left.

When the secondary battery is used as an auxiliary power source to the commercial power supply, there is a problem that the secondary battery cannot be used where an AC plug of an image forming apparatus body is removed from a socket. Therefore, despite the existence of stored electric power, maintenance work for maintaining image quality cannot be automatically carried out, for example, rotating a toner cartridge to prevent fixation of toner.

Moreover, when an image forming apparatus that is previously not in use for a long time becomes suddenly used, for example, in an office, a situation may occur where print of good quality cannot be done because of the fixation of toner.

### BRIEF DESCRIPTION OF THE DRAWINGS

FIG. 1 shows an example of an image forming apparatus according to a first embodiment.

FIG. 2 shows an exemplary configuration of an image forming unit in the first embodiment.

FIG. 3 shows an exemplary configuration of a toner cartridge in the first embodiment.

FIG. 4 is a block diagram showing maintenance control in the first embodiment.

FIG. 5 is a flowchart for explaining maintenance control operation in the first embodiment.

FIG. 6 shows an example of an image forming apparatus according to a second embodiment.

FIG. 7 is a block diagram showing maintenance control in the second embodiment.

FIG. 8 shows an example of a screen for setting maintenance control parameters in the second embodiment.

FIG. 9 is a flowchart for explaining toner stirring maintenance control in the second embodiment.

FIG. 10 is a flowchart for explaining developer stirring maintenance control in the second embodiment.

### DETAILED DESCRIPTION

According to an exemplary embodiment, there is provided an image forming apparatus which has a secondary battery having electricity stored therein by a power generation method other than a commercial power supply, such as a solar panel, in addition to the commercial power supply, and in which maintenance control for basic image quality maintenance can be carried out even when an AC plug of an apparatus body is removed from a socket for a long time, and in which maintenance control aimed at maintaining image quality can be carried out even in sleep mode when there is power supply from an AC socket, and a maintenance control method is provided.

In general, according to one embodiment, an image forming apparatus includes a solar panel, an electric storage unit which is supplied with electric power from the solar panel and a commercial power supply and stores electricity, a power supply disconnection detecting unit which detects power supply disconnection from the commercial power supply, and a maintenance control unit for power supply disconnection which carries out maintenance control using stored electricity from the solar panel if the power supply disconnection from the commercial power supply is detected by the power supply disconnection detecting unit.

Hereinafter, embodiments will be described with reference to the drawings. Image forming apparatuses according to exemplary embodiments include, for example, a color copy machine which carries out color and monochrome print with high resolution, and a multi-function peripheral (MFP) which can carry out various kinds of processing such as a function to copy an original document, a function to communicate with an external device, and a function to transmit, receive, and print as a facsimile apparatus.

### First Embodiment

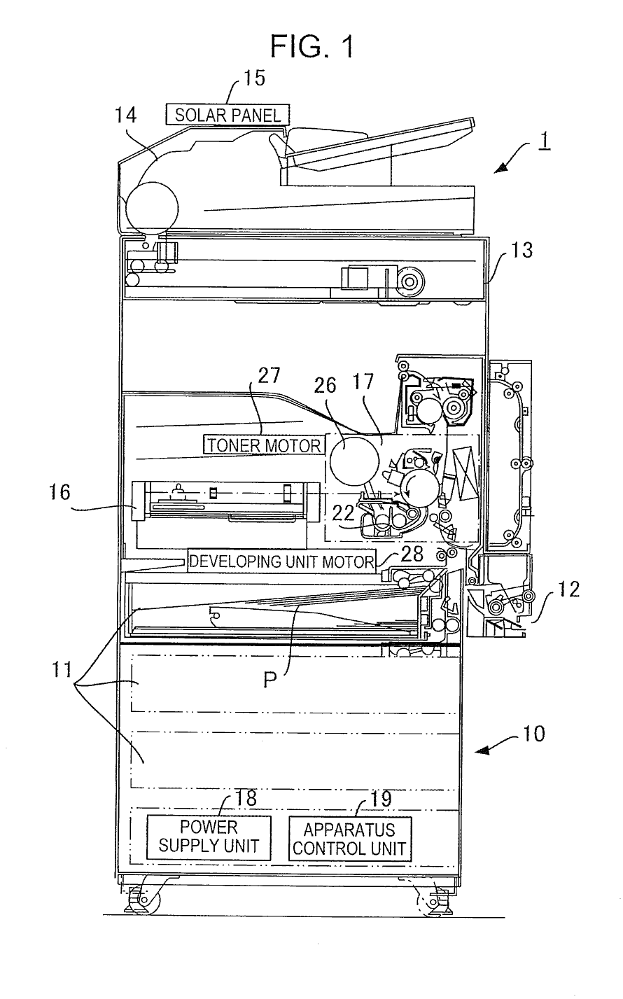

FIG. 1 shows an exemplary configuration of an image forming apparatus. In this embodiment, an image forming apparatus capable of carrying out monochrome copy, development and print is supposed.

Similarly to a conventional copy machine, this image forming apparatus 1 has a paper supply cassette 10 in which many copy sheets P are housed, in a lower part of a body. The apparatus 1 also has an LCF paper supply device 11 for supplying the sheets P of the same size in a large volume, and a manual insertion paper supply device 12 for manually supplying sheets of various sizes and various kinds.

In an upper part of the image forming apparatus 1, an image reading unit 13 for reading a document placed thereon and an automatic document feeder (ADF) 14 for feeding a document into the image reading unit 13 are provided. Moreover, a solar panel 15 is provided as an auxiliary power source.

In a middle part of the image forming apparatus 1, a laser optical system 16 is provided which writes image data that is read by the image reading unit 13, and an image forming unit 17 is provided which forms an image to be printed on the supplied copy sheet P. Moreover, a power supply unit 18 which supplies DC power to the image forming apparatus 1, and an apparatus control unit 19 which controls the entire image forming apparatus 1 are provided.

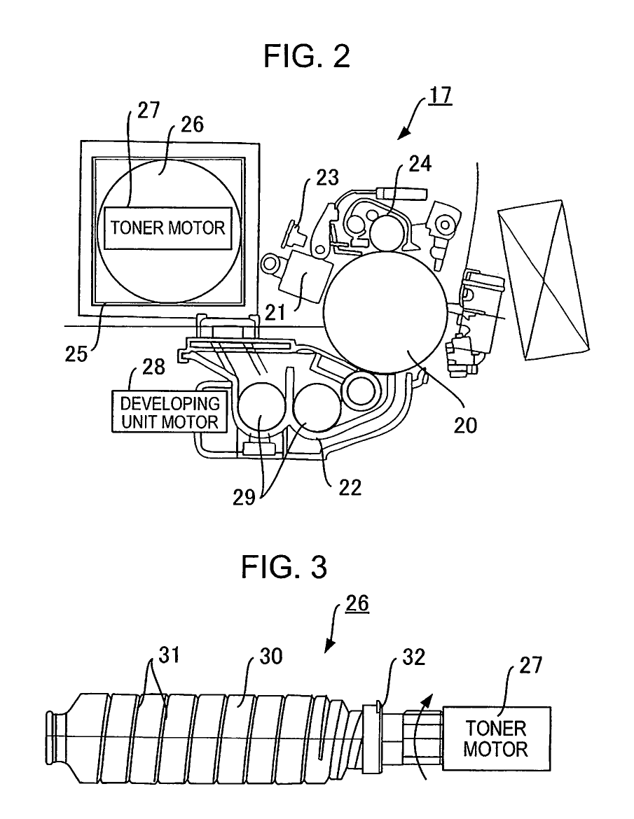

First, the configuration of the image forming unit 17 will be described with reference to FIG. 2 as well as FIG. 1. The image forming unit 17 is provided with a photoconductive drum 20 having an electrostatic latent image corresponding to the image data formed on a surface thereof by the laser optical system 16, a charger 21 which transfers the electrostatic latent image on the photoconductive drum 20 to a copy sheet, a developing unit 22 which supplies toner to the copy sheet to which the electrostatic latent image is transferred, and thus provides an image, a neutralizing lamp 23 which neutralizes a charge on the surface of the photoconductive drum 20, and a cleaner 24 which cleans the surface of the photoconductive drum 20. The developing unit 22 is supplied with toner from a toner cartridge 26 supported by a toner container supporting unit 25. A toner motor 27 which engages with the toner cartridge 26 and thus rotates the toner cartridge 26 is provided to the back of the toner container supporting unit 25. In order to stir the toner in the developing unit 22, a developing unit motor 28 and a mixer or auger 29 which stirs the developer according to the rotation of the developing unit motor 28 are provided.

FIG. 3 shows the overall configuration of the toner cartridge 26. A container body 30 in which the toner is housed is a cylindrical plastic container. The toner cartridge 26 is rotated by the toner motor 27 according to a state of toner consumption. A helical groove 31 is formed on a periphery of the container body 30. This groove 31 forms protruding wall surfaces on an inner side of the container body 30. The toner situated in concave parts between the protruding wall surfaces is moved toward a toner supply port as the toner cartridge 26 rotates. By rotation in the backward direction, fixation of the toner can be prevented without moving the toner toward the toner supply port. In order to carry out maintenance control to maintain image quality, the toner motor 27 is rotated backward when carrying out maintenance control operation.

The toner cartridge 26 has a bottle cap 32 engaging with the toner motor 27 which rotates the toner cartridge 26. This bottle cap 32 is configured in such a manner that a thread formed on an inner side of the bottle cap 32 screws on a thread formed on an outer side of a distal end part of the container body 30.

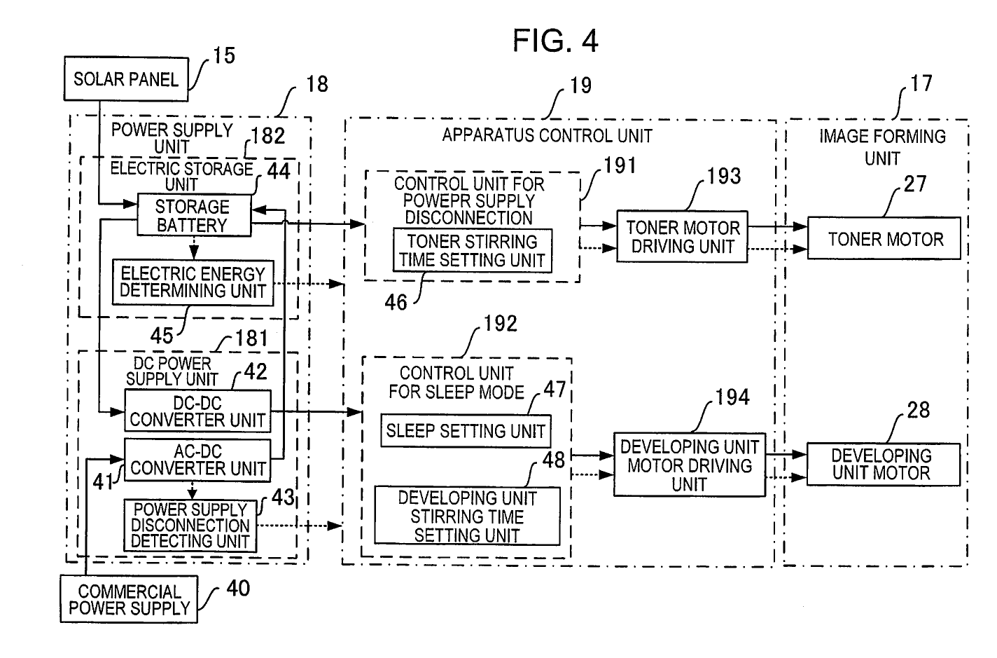

Next, FIG. 4 shows a block diagram for maintenance control to maintain image quality. This maintenance control involves the solar panel 15, the power supply unit 18, the apparatus control unit 19, and the image forming unit 17. Solid arrows shown in FIG. 4 indicate flows of power supply and broken lines indicate flows of control signals.

In an ordinary embodiment, the solar panel 15 is installed on top of the image forming apparatus 1 in order to receive illuminating light within the room or incoming sunlight from the window and thus generate electric power. However, the solar panel 15 may be attachable and removable and may be moved to and installed in a place where light can be received, as needed. In order to acquire necessary electric power for maintenance control when power supply is disconnected, the solar panel 15 preferably has a large area. However, since an installation area is limited, the solar panel 15 of as high efficiency as possible is used.

The power supply unit 18 has a DC power supply unit 181 which rectifies an AC commercial power supply 40 to DC, and an electric storage unit 182 which stores electric power supplied from the solar panel 15 and the commercial power supply 40.

The DC power supply unit 181 has an AC-DC converter unit 41 which converts AC power from the commercial power supply 40 to DC power in order to store the power in the electric storage unit 182, and a DC-DC converter unit 42 which converts DC power outputted from the electric storage unit 182, for example, to DC voltages of 5V and 12V, which are optimum to operate the apparatus control unit 19.

The DC power supply unit 181 also has a power supply disconnection detecting circuit 43 which detects that the commercial power supply is cut off when the AC plug is removed from the AC socket of the commercial power supply 40, or when continuity is interrupted by a circuit breaker, or at the time of outage.

The electric storage unit 182 has a storage battery 44 which, as a secondary battery, stores electric power supplied from the solar panel 15 and the commercial power supply 40, and an electric energy determining unit 45 which determines a level of electric power stored in the storage battery 44. The storage battery 44 is preferably small and highly efficient and capable of storing high electric power, such as a lithium-ion battery.

The apparatus control unit 19 has a control unit for power supply disconnection 191 which carries out maintenance control operation to maintain image quality based on a result of detection of power supply disconnection by the power supply disconnection detecting unit 43, a control unit for sleep mode 192 which carries out maintenance control operation to maintain image quality when the apparatus is in sleep mode for the purpose of power saving though power is supplied from the commercial power supply 40, a toner motor driving unit 193 which outputs a control signal to the toner motor 27 in order to stir toner during maintenance control operation, and a developing unit motor driving unit 194 which outputs a control signal to the developing unit motor 28 in order to carry out stirring in the developing unit during maintenance control operation. The control unit for power supply disconnection 191 has a toner stirring time setting unit 46 which holds maintenance control setting parameters such as a time period between occurrence of power supply disconnection and stirring with the toner motor 27, as needed.

The control unit for sleep mode 192 has a sleep setting unit 47 which sets a time when the apparatus should shift to sleep mode, which is one of power-saving modes, with a passage of a predetermined time after there is no operation any longer, and a developing unit stirring time setting unit 48 which holds maintenance control setting parameters such as a time period of the stirring with the developing unit motor 28 in sleep mode.

A operation schedule of the toner stirring time setting unit 46 and the developing unit stirring time setting unit 48 is preset in a non-volatile memory such as EEPROM. Alternatively, maintenance control may be carried out when the stored electricity reaches 100%, without setting the operation schedule.

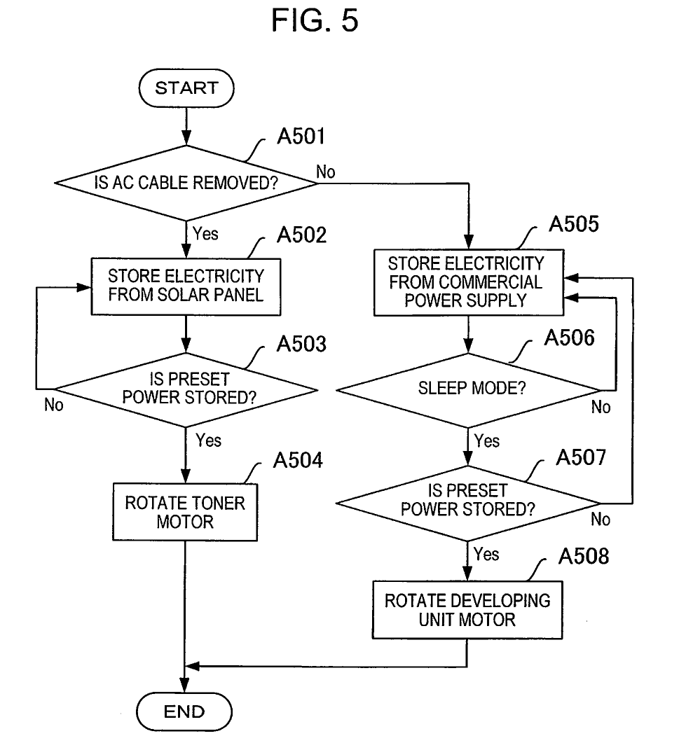

Next, maintenance control operation to maintain image quality will be described with reference to the flowchart of FIG. 5. The maintenance control to maintain image quality refers to carrying out maintenance of mechanical parts involved in image formation during a period when the image forming apparatus 1 is not in use, so that print of good image quality can be carried out even when the image forming apparatus 1 that is previously not in use for a long time is suddenly used, for example, in an office, and thus maintaining image quality.

The image forming apparatus 1 that is not in use for a long time is often placed in the corner of a warehouse or room after the AC cable is removed from the socket. Therefore, first, in ACT A501, whether the AC cable is removed from the socket is detected. The power supply disconnection detecting unit 43 may make a determination mechanically by using a switch to detect whether the AC cable is inserted or removed. However, in this embodiment, other cases than where the AC plug is removed from the AC socket are also considered. The power supply disconnection detecting circuit 43 that can cope with, for example, the case where continuity is interrupted by the circuit breaker or the case where the commercial power supply is cut off because of outage is provided. There are various methods for electrically detecting power supply disconnection. However, a relay circuit may be connected to a part of an output of the AC-DC converter unit 41 so as to detect power supply disconnection.

When power supply disconnection because of the removal of the AC plug or the like is detected (ACT A501, Yes), whether electricity is stored from the solar panel 15 is checked in ACT A502. However, electricity may be stored from the solar panel 15 even when the AC plug is not removed from the socket.

In ACT A503, whether electric energy to be consumed for the maintenance control subsequent to this operation is stored in the storage battery 44 is determined. This determination is made based on the electric energy indicated by the electric energy determining unit 45. To accurately determine the electric energy stored in the storage battery 44, temperature, current and voltage must be observed using an IC such as coulomb counter. However, to make the determination simple, an assumption can be made that as long as a preset voltage or a higher voltage is outputted from the storage battery 44, the electric energy to be consumed for the maintenance control subsequent to this operation or greater electric energy is substantially stored.

When the preset electric energy is not stored in the storage battery 44 (ACT A503, No), the operation returns to ACT A502 and storage of electricity from the solar panel 15 is continued. When the preset electric energy is stored in the storage battery 44 (ACT A503, Yes), the toner motor driving unit 193 rotates the toner motor 27 by a predetermined number of rotations or for a predetermined time period, based on the operation schedule by the toner stirring time setting unit 46 (ACT A504).

When an electric storage capacity of the storage battery 44 is small, or when the installed solar panel has a small nominal maximum output, predetermined maintenance control may be carried out when electricity is stored. In this case, the toner stirring time setting unit 46 need not be provided.

When the AC plug is inserted and power supply disconnection is not detected (ACT A501, No), the maintenance control operation is carried out using the stored electricity from the commercial power supply 40 having a high electric storage efficiency, as shown in ACT A505. Also in this case, power generation by the solar panel 15 is not prohibited.

In ACT A506, whether the image forming apparatus 1 is in sleep mode is determined. Sleep mode is to substantially eliminate power consumption by the apparatus control unit 19 in order to save power where no operation is carried out for a predetermined period. Therefore, when the apparatus is in sleep mode, only standby power that is necessary for returning to normal mode is consumed. For example, minimum necessary power is consumed that is necessary for standby so that the apparatus can recover from sleep mode when an operator touches various buttons on a console panel, not shown, of the image forming apparatus 1, or when the image forming apparatus 1 has a network unit and a job is accepted from another PC connected to a network.

In ACT A507, whether the electric energy to be consumed for the maintenance control subsequent to this operation is stored in the storage battery 44 is determined. This determination is made based on the electric energy indicated by the electric energy determining unit 45. To accurately determine the electric energy stored in the storage battery 44, temperature, current and voltage must be observed using an IC such as coulomb counter. However, to make the determination simple, an assumption can be made that as long as a preset voltage or a higher voltage is outputted from the storage battery 44, the electric energy to be consumed for the maintenance control subsequent to this operation or greater electric energy is substantially stored.

When the preset electric energy is not stored in the storage battery 44 (ACT A507, No), the operation returns to ACT A505 and storage of electricity from the commercial power supply 40 is continued. When the preset electric energy is stored in the storage battery 44 (ACT A507, Yes), the developing unit motor driving unit 194 rotates the developing unit motor 28 by a predetermined number of rotations or fora predetermined time period, based on the operation schedule by the developing unit stirring time setting unit 48 (ACT A508).

In ACT A508, the developing unit motor 28 is rotated as an example of maintenance control. However, the rotation of the toner motor 27 carried out at the time of power supply disconnection may also be carried in addition to the rotation of the developing unit motor 28. Moreover, other kinds of maintenance control may also be carried out.

In this manner, according to the first embodiment, the secondary battery in which electricity is stored by the commercial power supply and also by other power generation methods than the commercial power supply, such as the solar panel, is provided. Therefore, even if the image forming apparatus is left for a long time in the state where the AC plug of the image forming apparatus body is removed from the AC socket, basic maintenance control to maintain image quality can be carried out. Moreover, when there is power supply from the AC socket, maintenance control operation to maintain image quality can be carried out when the apparatus is in sleep mode where only standby power is consumed.

Thus, since maintenance operation to maintain image quality that is usually carried out after recovery from sleep mode need not be carried out, a time taken for restoring print availability after the recovery from sleep mode is significantly reduced and the operation is improved. Since toner can be stirred even when there is no AC commercial power supply input, fixation of the toner can be prevented even after the apparatus is left unused for a long time. Therefore, satisfactory print can be carried out even when the apparatus is suddenly used.

Since both storage of electricity from the solar panel and storage of electricity from the commercial power supply are used, toner can be stirred as long as there is a predetermined amount of electric charge stored from the commercial power supply even if the apparatus is stored in the unplugged state from the AC socket, in a place where there is no light such as sunlight or fluorescent light.

Since toner can be stirred even when there is no AC power supply input, the apparatus with monitoring sample toner installed therein can be shipped.

### Second Embodiment

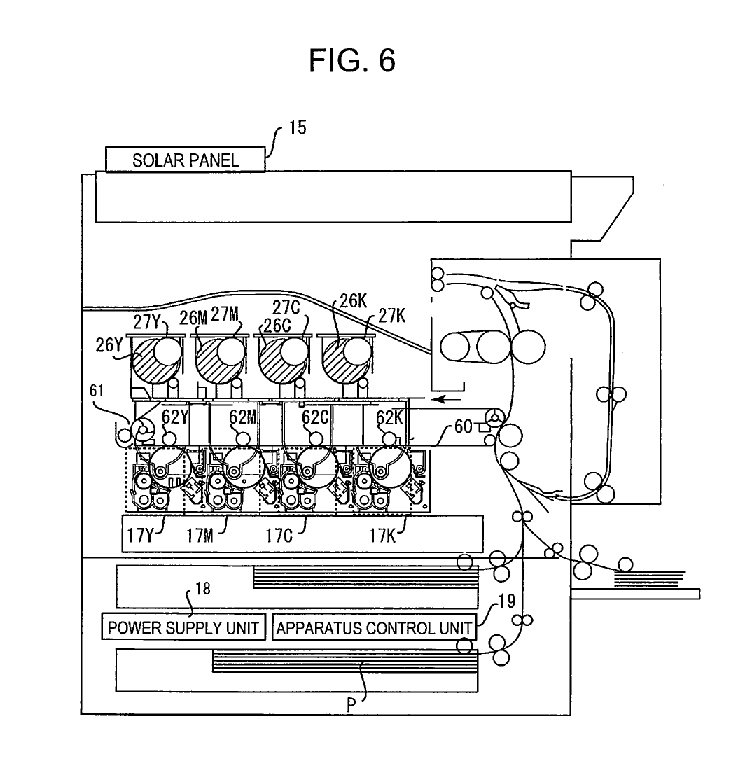

In the first embodiment, the image forming apparatus is assumed to be for monochrome. However, in this embodiment, maintenance control for a color image forming apparatus will be described. Moreover, necessary maintenance control items such as maintenance control for a transfer roller can be added depending on the apparatus, and therefore more detailed setting and change of maintenance control parameters can be realized. FIG. 6 shows an example of the apparatus according such embodiment. Compared with the image forming apparatus of FIG. 1, the image forming apparatus according to this embodiment has toner cartridges 26Y, 26M, 26C and 26K of each color and toner motors 27Y, 27M, 27C and 27K which stir toner within these toner cartridges, so that the colors of yellow (Y), magenta (M) and cyan (C) in addition to monochrome (K) can be printed. The apparatus also has image forming units 17Y, 17M, 17C and 17K corresponding to each color, a driving roller 61 which turns a transfer belt 60 for primary transfer of a latent image in each image forming unit, and transfer rollers 62Y, 62M, 62C and 62K.

In this embodiment, a type having a mixer and an auger provided within a cartridge is supposed, instead of the toner bottle-type toner cartridge used in the first embodiment. However, in both cases, toner is similarly stirred by the toner motor.

The image forming units 17Y, 17M, 17C and 17K have a developing unit, as in FIG. 2, and have developing unit motors 28Y, 28M, 28C and 28K which stir the developer in the developing unit.

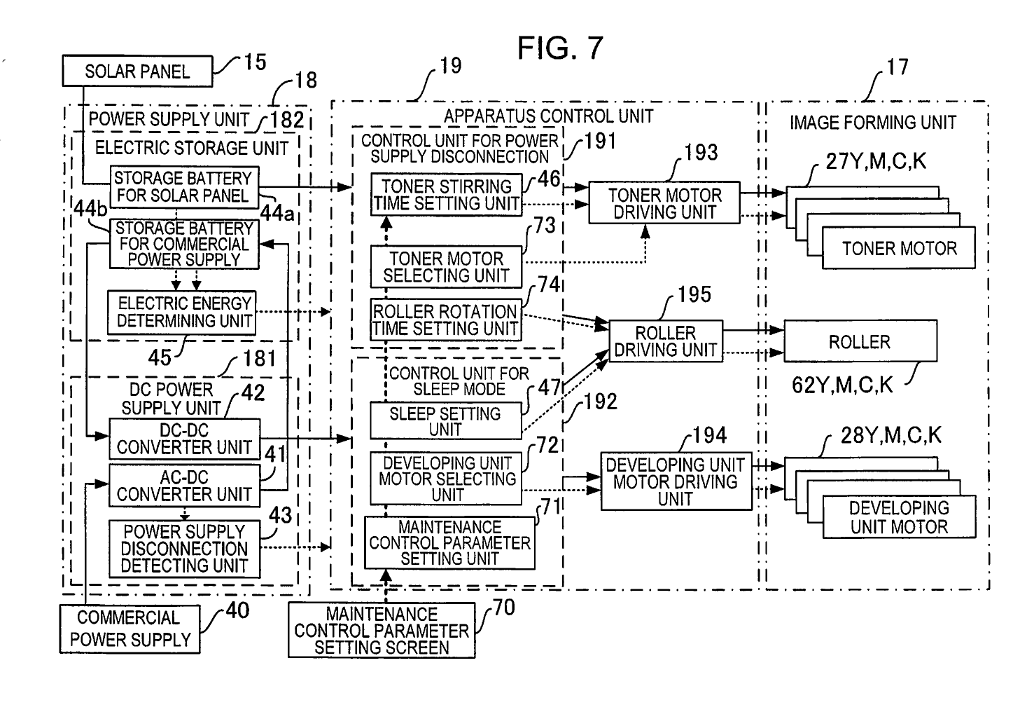

Next, the block diagram showing maintenance control in this embodiment as shown in FIG. 7 will be described. Solid lines shown in FIG. 7 indicate flows of power supply and broken lines indicate flows of control signals. The basic configuration is similar to FIG. 4. However, the storage battery 44 of the electric storage unit 182 includes two storage batteries, that is, a storage battery for solar panel 44a and a storage battery for commercial power supply 44b, provided exclusively for maintenance control at the time of power supply disconnection and at the time of sleep mode.

A maintenance control parameter setting screen 70 is provided to set maintenance control parameters for the apparatus control unit 19. In the control unit for sleep mode 192, there is provided a maintenance control parameter setting unit 71 in which the maintenance control parameters are stored, and a developing unit motor selecting unit 72 which selects which of the developing unit motors 28Y, 28M, 28C and 28K of each color should be operated, based on the amount of electricity stored in the storage battery for commercial power supply 44b.

In the control unit for power supply disconnection 191, a toner motor selecting unit 73 is provided which selects which rotation motor of the toner motors 27Y, 27M, 27C and 27K of each color should be operated, based on the amount of electricity stored in the storage battery for solar panel 44a.

Moreover, in this embodiment, a maintenance control item to prevent deformation of rubber or the like forming rollers such as the driving roller 61 and the transfer rollers 62Y, 62M, 62C and 62K due to long-term suspension of these rollers is newly added. According to this maintenance item, the transfer belt 60 is driven by a transfer belt motor, not shown, thereby rotating the driving roller 61 and the transfer rollers 62Y, 62M, 62C and 62K.

Thus, in FIG. 7, a roller rotation time setting unit 74 which sets a time for which the transfer belt 60 is driven to rotate these rollers, a roller driving unit 195 which outputs a control signal for roller rotation, and the driving roller 61 and the transfer rollers 62Y, 62M, 62C and 62K rotated according to the control signal, are added.

The maintenance control parameter setting unit 71 transfers maintenance control parameters relating to maintenance control carried out at the time of power supply disconnection, to the toner stirring time setting unit 46, the toner motor selecting unit 73, and the roller rotation time setting unit 74. The maintenance control parameters transferred to the toner stirring time setting unit 46, the toner motor selecting unit 73, and the roller rotation time setting unit 74 are necessary at the time of power supply disconnection and therefore may be preferably saved in a non-volatile memory such as EEPROM.

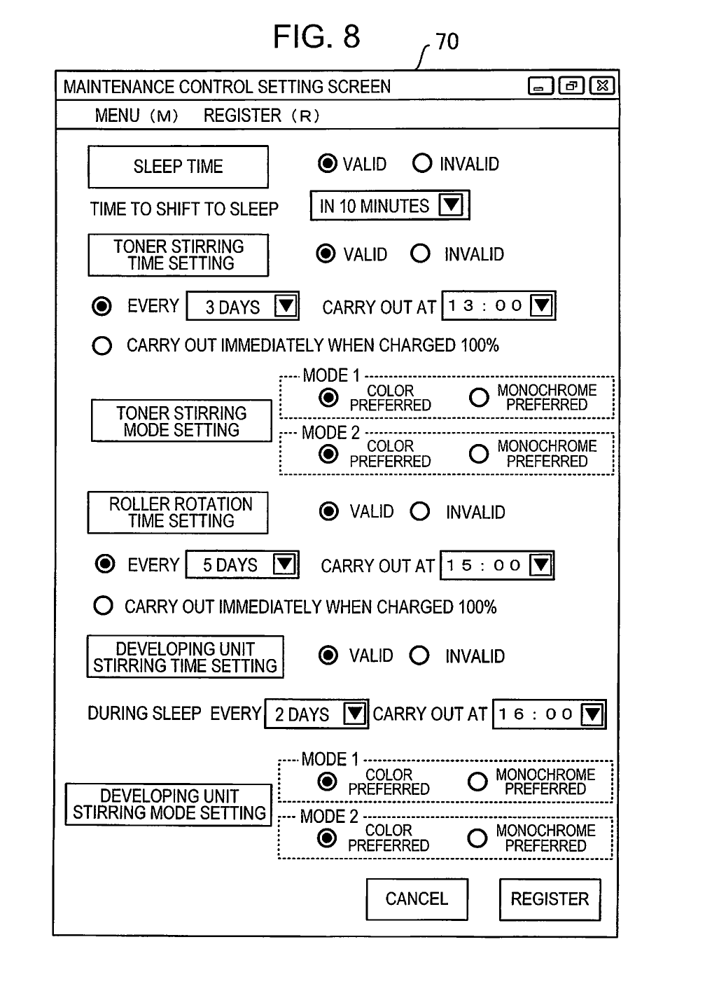

Here, the maintenance control parameter setting screen 70 will be described with reference to FIG. 8. The maintenance control parameter setting screen as shown in FIG. 8 is displayed on the console panel, not shown, of the image forming apparatus 1. Parameters are set by operating a touch panel or the like. Alternatively, a network function is used and displaying and setting is carried out from a print screen setting screen on a PC or the like connected to the network.

First, in setting “sleep time”, whether sleep mode is made valid or invalid can be designated using checkboxes. When sleep mode is made valid, a time to shift to sleep can be further designated.

In “toner stirring time setting”, whether to carry out toner stirring maintenance control at the time of power supply disconnection is selected using the checkboxes of valid and invalid. In the case of carrying out toner stirring maintenance control, a time interval of maintenance control and an operation time can be inputted. Alternatively, operation can also be set to start when the amount of electricity stored in the storage battery for solar panel 44a reaches a preset amount of electricity stored, without setting such schedule. This setting can be used when control cannot be carried out according to a preset maintenance control schedule even where this schedule is set, such as when the solar panel 15 having a small nominal maximum output is used or when the storage battery for solar panel 44a having a small electric storage capacity is used.

In “toner stirring mode setting”, toner stirring modes can be selected, for example, “mode 1” and “mode 2”. Moreover, control types can be selected such as “color preferred” and “monochrome preferred” for each toner stirring mode. This is because toner stirring maintenance control carried out at the time of power supply disconnection uses the relatively small solar panel 15 and the storage battery for solar panel 44a having a relatively small electric storage capacity and therefore when the solar panel 15 outputs very small electric power due to the place where the image forming apparatus 1 is arranged, daylight hours and the like, quite a number of days are needed to achieve full charge, and it may be difficult to rotate all the toner motors of the colors Y, M, C and K even when electricity is stored.

The solar panel 15 with a size, for example, approximately 5 centimeters by 20 centimeters, is supposed. At the maximum, this size or so is optimum when the solar panel is installed on top of the image forming apparatus 1. The nominal maximum output of the solar panel having approximately this size is approximately 1 W. The nominal maximum output is an output generated by sunlight in midsummer. Therefore, the amount of power generated is significantly reduced, depending on seasons, weather and daylight hours. For example, on a rainy day in winter, the output is reduced to approximately one-twentieth to one-hundredth the nominal maximum output. Also, power generation with a fluorescent light in the room or the like is one-twentieth to one-hundredth the nominal maximum output. In the worst case scenario, only about 0.01 W can be generated.

If the rotation of the toner motors 27Y, 27M, 27C and 27K needs, for example, power of approximately 15 W and a rotation time necessary for maintenance control is approximately 1 minute, electric energy of 0.25 Wh is required. Then, even if rotation control of one toner motor takes approximately 25 hours and as many as 8 daylight hours per day are estimated, an electric storage period of approximately 3 days is required. Therefore, an electric storage period of approximately 12 days is needed to rotate all the four toner motors. If all the four toner motors are to be rotated in single maintenance control, the storage battery for solar panel 44a needs an electric storage capacity of 1 Wh. This is equivalent to the electrical storage capacity of about 1 to 2 AA rechargeable batteries.

When the electric storage capacity of the storage battery for solar panel 44a is increased excessively, a number of days are taken to achieve full charge, and when a certain amount of electricity is not stored, proper voltage and current for the maintenance control operation are not outputted. Therefore, the electric storage capacity of the storage battery for solar panel 44a cannot be increased too much.

Meanwhile, the rotation of the developing unit motors 28Y, 28M, 28C and 28K, which will be described later, needs, for example, power of approximately 80 W per developing unit motor. Therefore, since the electric storage capacity of the storage battery for solar panel 44a cannot meets this need, the storage battery for commercial power supply 44b having at least an electric storage capacity of 5 Wh or greater is used. The storage battery for commercial power supply 44b stores electricity from the commercial power supply 40 and therefore may be a relatively large 50 Wh-class storage battery used in a laptop computer.

In “roller rotation time setting”, whether to carry out maintenance control for roller rotation can be set. In a case of carrying out maintenance control for roller rotation, an interval of maintenance control and an operation time can be inputted. Alternatively, operation can also be set to start when the amount of electricity stored in the storage battery for solar panel 44a or the storage battery for commercial power supply 44b reaches a preset amount of electricity stored, without setting such schedule.

In “developing unit stirring time setting”, whether to carry out maintenance control for the developing unit motors 28Y, 28M, 28C and 28K can be set. In a case of carrying out rotation maintenance control for the developing unit motors, a time interval of maintenance control during sleep mode and an operation time can be inputted.

In “developing unit stirring mode setting”, as in “toner stirring mode setting”, developing unit stirring modes such as “mode 1” and “mode 2” can be selected. Moreover, control types such as “color preferred” and “monochrome preferred” can be selected for each developing unit stirring mode.

In this manner, after various maintenance control parameters are set on the maintenance control parameter setting screen 70, a registration button is pressed for registering the parameters, and a cancel button is pressed for canceling the parameters and resetting parameters. There may be a mode in which optimum maintenance control is automatically carried out without manually setting maintenance control parameters.

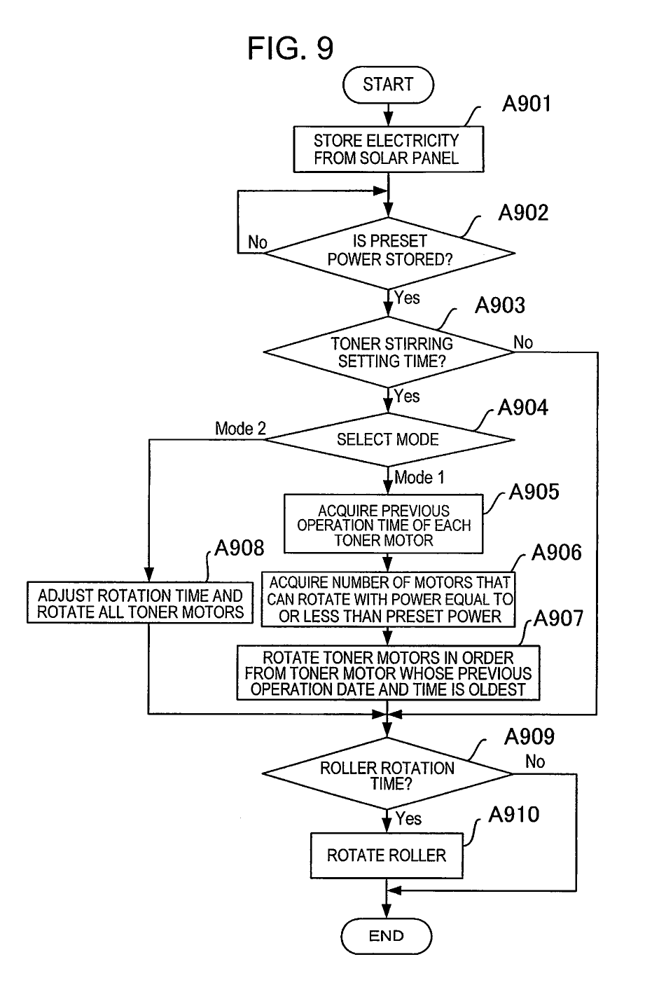

Next, maintenance control for toner stirring will be described with reference to the flowchart of FIG. 9. In the flowchart continuing from ACT A901, the toner motors 27Y, 27M, 27C and 27K are rotated using electricity stored from the solar panel 15.

When preset power is not stored in the storage battery for solar panel 44a from the solar panel 15 (ACT A902, No), the apparatus waits until preset power necessary for carrying out toner stirring maintenance control is stored. When the preset power is stored in the storage battery for solar panel 44a (ACT A902, Yes), the operation goes to subsequent ACT A903. In ACT A903, whether it is the toner stirring time now that is set on the maintenance control parameter setting screen 70 is determined. When it is the toner stirring setting time (ACT A903, Yes), a toner stirring mode setting condition is confirmed. When mode 1 is selected (ACT A904, mode 1), the operation time at which the toner motors 27Y, 27M, 27C and 27K are previously rotated is acquired (ACT A905). As for such history information, a unit to manage the history information may be additionally provided in the control unit for power supply disconnection 191. Alternatively, an area which stores the time at which the previous maintenance control is operated may be provided for each toner motor within the roller rotation time setting unit 74 including EEPROM or the like, and that time may be read out.

In ACT A906, the number of motors that can rotate for a predetermined time with the stored electric energy is calculated. Then, in ACT A907, when control type is “color preferred”, the toner motors are rotated in order from the toner motor whose previous operation time is the oldest. When control type is “monochrome preferred”, the monochrome toner motor 27K is rotated first.

When the toner stirring mode is mode 2 in ACT A904 (ACT A904, mode 2), all the toner motors are rotated. However, the predetermined time is adjusted so that power consumption does not exceed the stored electric energy (ACT A909). When control type in “toner stirring mode” is “color preferred”, maintenance control is carried out to all the toner motors for uniform time periods. When control type is “monochrome preferred”, the rotation time of the monochrome toner motor 27K is made longer than the rotation time of the color toner motors 27Y, 27M and 27C.

When it is not the toner stirring time (ACT A903, No), the operation goes to ACT A909. In ACT A909, whether it is the roller rotation time is determined. When it is the roller rotation time (ACT A909, Yes), the transfer belt 60 is driven for a predetermined time in order to rotate the driving roller 61 and the transfer rollers 62Y, 62M, 62C and 62K (ACT A910). When it is not the roller rotation time (ACT A909, No), the flowchart is finished. When the various kinds of maintenance control are set as invalid on the maintenance control parameter setting screen 70, no maintenance control operation is carried out. Since the amount of electricity stored is limited, the rotation of the toner motors and the rotation of the rollers should be set at different times in consideration of the amount of power generated from the solar panel 15. Such maintenance control at the time of power supply disconnection is best effort control because this control depends on the amount of electricity stored.

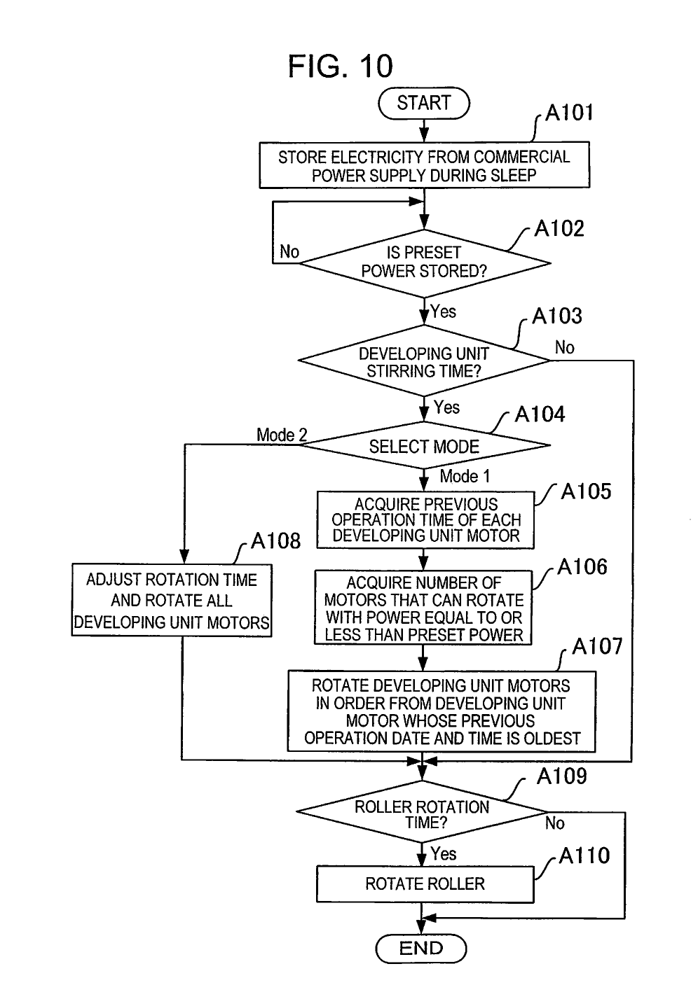

Next, the flowchart of developing unit motor stirring maintenance control carried out at the time of sleep mode will be described with reference to FIG. 10. In the flowchart continuing from ACT A101, the developing unit motors 28Y, 28M, 28C and 28K are rotated using electricity stored from the commercial power supply 40 during sleep mode.

When preset power is not stored in the storage battery for commercial power supply 44b from the commercial power supply 40 (ACT A102, No), the apparatus waits until the preset power necessary for developing unit stirring maintenance control is stored. When the preset power is stored in the storage battery for commercial power supply 44b (ACT A102, Yes), the operation goes to subsequent ACT A103. In ACT A103, whether it is a developing unit stirring time now that is set on the maintenance control parameter setting screen 70 is determined. When it is the developing unit stirring time (ACT A103, Yes), a developing unit stirring mode setting condition is confirmed. When mode 1 is selected (ACT A104, mode 1), the operation time at which the developing unit motors 28Y, 28M, 28C and 28K are previously rotated is acquired (ACT A105). As for such history information, a unit to manage the history information may be additionally provided in the control unit for sleep mode 192. Alternatively, an area which stress the time at which the previous maintenance control is operated may be provided within the maintenance control parameter setting unit 71.

In ACT A106, the number of motors that can rotate for a predetermined time with the stored electric energy is calculated. Then, in ACT A107, when control type is “color preferred”, the developing unit motors are rotated in order from the developing unit motor whose previous operation time is the oldest. When control type is “monochrome preferred”, the monochrome developing unit motor 28K is rotated first.

When the developing unit stirring mode is mode 2 in ACT A104 (ACT A104, mode 2), all the developing unit motors are rotated. However, the predetermined time is adjusted so that power consumption does not exceed the stored electric energy (ACT A109). When control type in “developing unit stirring mode” is “color preferred”, maintenance control is carried out to all the developing unit motors for uniform time periods. When control type is “monochrome preferred”, the rotation time of the monochrome developing unit motor 28K is made longer than the rotation time of the color developing unit motors 28Y, 28M and 28C.

When it is not the developing unit stirring time (ACT A103, No), the operation goes to ACT A109. In ACT A109, whether it is the roller rotation time is determined. When it is the roller rotation time (ACT A109, Yes), the transfer belt 60 is driven for a predetermined time in order to rotate the driving roller 61 and the transfer rollers 62Y, 62M, 62C and 62K (ACT A110). When it is not the roller rotation time (ACT A109, No), the flowchart is finished. When the various kinds of maintenance control are set as invalid on the maintenance control parameter setting screen 70, no maintenance operation is carried out.

In this embodiment, the storage battery for solar panel 44a and the storage battery for commercial power supply 44b are provided for the specific purposes. However, when the amount of power generated by the solar panel 15 is small and there is excess electricity stored in the storage battery for commercial power supply 44b, this power may be supplied to the storage battery for solar panel 44a.

In the image forming apparatus of a type that can lift up the transfer rollers 62Y, 62M, 62C and 62K, maintenance control to lift up the rollers to prevent deformation of the rollers in sleep mode or at the time of power supply disconnection may be newly added. Maintenance control for rotating other rollers such as carrying rollers may also be carried out.

Moreover, in the maintenance operation in sleep mode, stirring rotation of the toner motors carried out at the time of power supply disconnection may be added to maintenance control items.

As described above, according to the second embodiment, since the dedicated storage batteries for storing electricity from the commercial power supply and the solar panel are provided, the amount of electricity stored can be optimally managed in addition to the advantage of the first embodiment. Moreover, since types of maintenance control and operation modes can be set and changed on the maintenance control parameter setting screen, more detailed maintenance control can be carried out.

In this manner, according to the embodiments, the maintenance operation to maintain image quality that is normally carried out after recovery from sleep mode need not be carried out. Therefore, the time taken for restoring print availability after the recovery from sleep mode is significantly reduced and therefore the operation is improved. Since toner can be stirred even when there is no AC commercial power supply input, fixation of the toner can be prevented even after the apparatus is left unused for a long time. Therefore, satisfactory print can be carried out even when the apparatus is suddenly used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and sprit of the inventions.

What is claimed is:

1. An image forming apparatus comprising:
a solar panel;
an electric storage unit which is supplied with electric power from the solar panel and a commercial power supply and stores electricity;
a power supply disconnection detecting unit which detects power supply disconnection from the commercial power supply; and
a maintenance control unit for power supply disconnection which carries out maintenance control using stored electricity from the solar panel if the power supply disconnection from the commercial power supply is detected by the power supply disconnection detecting unit.

2. The apparatus according to claim 1, further comprising a maintenance control unit for sleep mode which carries out maintenance control using stored electricity from the commercial power supply after the apparatus shifts to sleep mode where the commercial power supply is provided and the apparatus is not used for a predetermined time.

3. The apparatus according to claim 2, further comprising a toner motor driving unit which outputs a control signal for stirring toner within a toner cartridge for a predetermined time, and a toner motor which stirs the toner within the toner cartridge according to the control signal from the toner motor driving unit,
wherein the maintenance control unit for power supply disconnection carries out maintenance control for rotating the toner motor.

4. The apparatus according to claim 3, further comprising a developing unit motor driving unit which outputs a control signal for stirring developer within a developing unit for a predetermined time, and a developing unit motor which stirs the developer within the developing unit according to the control signal from the developing unit motor driving unit,
wherein the maintenance control unit for sleep mode carries out maintenance control for rotating the developing unit motor.

5. An image forming apparatus comprising:
a solar panel;
a first storage battery which is supplied with electric power from the solar panel and stores electricity;
a DC power supply unit which converts a commercial power supply to direct current;
a second storage battery which is supplied with electric power from the DC power supply unit and stores electricity;
a power supply disconnection detecting unit which detects power supply disconnection from the commercial power supply;
a maintenance control unit for power supply disconnection which carries out maintenance control using the first storage battery if the power supply disconnection from the commercial power supply is detected by the power supply disconnection detecting unit; and
a maintenance control unit for sleep mode which carries out maintenance control using the second storage battery after the apparatus shift to sleep mode where the commercial power supply is provided and the apparatus is not used for a predetermined time.

6. The apparatus according to claim 5, wherein the maintenance control unit for power supply disconnection further comprises a toner motor driving unit which outputs a control signal for stirring toner within a toner cartridge for a predetermined time, and
a toner motor which stirs the toner within the toner cartridge according to the control signal from the toner motor driving unit, and
carries out maintenance control for rotating the toner motor.

7. The apparatus according to claim 6, wherein if a plurality of the toner motors are provided, the maintenance control unit for power supply disconnection adjusts rotation time of the toner motors according to an electric storage level in the first storage battery.

8. The apparatus according to claim 7, wherein if the plurality of the toner motors are provided, the maintenance control unit for power supply disconnection further comprises a toner motor selecting unit which selects the toner motor that should be rotated according to the electric storage level in the first storage battery.

9. The apparatus according to claim 8, wherein the toner motors are rotated in order from the toner motor whose previous rotation time is the oldest of the toner motors selected by the toner motor selecting unit.

10. The apparatus according to claim 9, wherein the maintenance control unit for sleep mode further comprises a developing unit motor driving unit which outputs a control signal for stirring developer within a developing unit for a predetermined time, and
a developing unit motor which stirs the developer within the developing unit according to the control signal from the developing unit motor driving unit, and
carries out maintenance control for rotating the developing unit motor.

11. The apparatus according to claim 10, wherein if a plurality of the developing unit motors are provided, the maintenance control unit for sleep mode adjusts rotation time of the developing unit motors according to an electric storage level in the second storage battery.

12. The apparatus according to claim 11, wherein if the plurality of the developing unit motors are provided, the maintenance control unit for sleep mode further comprises a developing unit motor selecting unit which selects the developing unit motor that should be rotated according to the electric storage level in the second storage battery.

13. The apparatus according to claim 12, wherein the developing unit motors are rotated in order from the developing unit motor whose past rotation time is the oldest of the developing unit motors selected by the developing unit motor selecting unit.

14. The apparatus according to claim 13, further comprising plural rollers forming a transfer mechanism to form a color image, and a roller driving unit which rotates these rollers,
wherein the maintenance control unit for power supply disconnection or the maintenance control unit for sleep mode carries out maintenance control for rotating the rollers.

15. The apparatus according to claim 14, further comprising a maintenance control parameter setting unit which selects and sets maintenance control parameters including type, maintenance control interval and maintenance control time, of a plurality of the maintenance control carried out at the time of the power supply disconnection or at the time of sleep mode.

16. A maintenance control method for an image forming apparatus comprising:
storing electricity in a first storage battery which is supplied with electric power from a solar panel;
converting a commercial power supply to direct current by a DC power supply unit;
storing electricity in a second storage battery which is supplied with electric power from the DC power supply unit;
detecting power supply disconnection from the commercial power supply by a power supply disconnection detecting unit;
executing maintenance control using power supply from the first storage battery if the power supply disconnection from the commercial power supply is detected by the power supply disconnection detecting unit; and
where the commercial power supply is provided and the apparatus is not used for a predetermined time, shifting to sleep mode and carrying out maintenance control using power supply from the second storage battery.

17. The method according to claim 16, wherein the maintenance control carried out using power supply from the first storage battery includes:
rotating a toner motor and stirring toner within a toner cartridge;
if a plurality of the toner motors are provided, calculating the number of toner motors that can rotate according to an amount of electricity stored in the first storage battery; and
rotating the toner motors in order from the toner motor whose previous rotation time is the oldest.

18. The method according to claim 16, wherein the maintenance control carried out using power supply from the first storage battery includes:
rotating a toner motor and stirring toner within a toner cartridge; and
adjusting time during which rotation can be carried out according to an amount of electricity stored in the first storage battery, if a plurality of the toner motors are provided.

19. The method according to claim 16, wherein the maintenance control carried out using power supply from the second storage battery includes:
rotating a developing unit motor and stirring developer within a developing unit;
if a plurality of the developing unit motors are provided, calculating the number of developing unit motors that can rotate according to an amount of electricity stored in the second storage battery; and
rotating the developing unit motors in order from the developing unit motor whose previous rotation time is the oldest.

20. The method according to claim 16, wherein the maintenance control carried out using power supply from the second storage battery includes:
rotating a developing unit motor and stirring developer within a developing unit; and
adjusting time during which rotation can be carried out according to an amount of electricity stored in the second storage battery, if a plurality of the developing unit motors are provided.
